(19) United States
(12) Patent Application Publication
(10) Pub. No.: US 2022/0394500 A1
(43) Pub. Date: Dec. 8, 2022

(54) Method and Apparatus for Aircraft Traffic Management

(71) Applicant: Telefonaktiebolaget LM Ericsson (publ), Stockholm (SE)

(72) Inventors: Yi Geng, Nanjing Jiangsu (CN); Cuichun Xia, Nanjing (CN); Hao Chen, Nanjing (CN)

(21) Appl. No.: 17/774,256

(22) PCT Filed: Nov. 22, 2019
(86) PCT No.: PCT/CN2019/120260

§ 371 Date: May 4, 2022

(51) Int. Cl. H04W 16/28; G08G 5/00; H04W 4/42; H04B 7/185

(52) U.S. Cl. CPC H04W 16/28; G08G 5/0013; H04W 4/42; H04B 7/18506

(57) ABSTRACT

Various embodiments of the present disclosure provide method and apparatus for aircraft traffic management. The method performed by an aircraft traffic management device comprises determining at least one cell shaping parameter based on cell information and a flight route of an aircraft. The method further comprises sending a request for creating at least one cell shaping beam for covering at least a part of the flight route of the aircraft to an operations support system, OSS, wherein the request includes the at least one cell shaping parameter.

### FIELD OF THE INVENTION

The present disclosure generally relates to communication networks, and more specifically, to method and apparatus for aircraft traffic management.

### BACKGROUND

This section introduces aspects that may facilitate a better understanding of the disclosure. Accordingly, the statements of this section are to be read in this light and are not to be understood as admissions about what is in the prior art or what is not in the prior art.

Aircraft (such as drone) applications are becoming increasingly common. For example, drones may work in so many areas, such as drone for aerial photography, drone for search and rescue operations, drone for agriculture, drone for shipping and delivery, drone for engineering applications, drones for three dimension (3D) mapping, drones for safety surveillance, drone for wireless Internet access, drone for research and nature science, etc. Drones are able to carry huge payloads and can serve users with a long flight time. Many sensors may be added to drones so that their operation can be highly optimized and they can work for dedicated applications with high performance. Mobile networks such as long term evolution (LTE) and the fifth generation (5G) (such as new radio (NR)) network are requested to support drone communication and/or passengers in a plane for example at a low-altitude.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As described above, mobile networks are requested to support aircraft communication and/or passengers in a plane for example at a low-altitude. However, the existing mobile networks such as cellular networks are optimized for terrestrial broadband communication like users on the ground and inside buildings with antennas of base stations being down-tilted to optimize the ground coverage and reduce inter-cell interference. Many challenges may arise for wireless devices such as drones and aerial user equipments (UEs) at a higher altitude for example 300 m or above. For example, with down-titled base station antenna, drones and planes flying in the sky may be served by side lobes of the base station antenna that have a smaller antenna gain than main lobe's antenna gain of the base station antenna. In addition, in cellular network, several challenges that lead to a different radio environment at a higher altitude may be line of sight (LOS) propagation/uplink interference, poor key performance indicators (KPI) caused by antenna sidelobes, sudden drop in signal strength, etc. Therefore, it may be desirable to provide an improved aircraft traffic management solution.

According to a first aspect of the present disclosure, there is provided a method performed by an aircraft traffic management device. The method comprises determining at least one cell shaping parameter based on cell information and a flight route of an aircraft. The method further comprises sending a request for creating at least one cell shaping beam for covering at least a part of the flight route of the aircraft to an operations support system, OSS, wherein the request includes the at least one cell shaping parameter.

In accordance with some exemplary embodiments, the method may further comprise determining the flight route of the aircraft based on at least one of position information regarding a flight mission of the aircraft, a service quality requirement of the aircraft, or the cell information.

In accordance with some exemplary embodiments, the position information of the flight mission of the aircraft may include a start position and an end position of the flight mission of the aircraft.

In accordance with some exemplary embodiments, the cell information may include at least one of aerial coverage capability of a cell, a coverage area of a cell, a load of a cell; an antenna orientation of a cell, or a cell shaping state of a cell.

In accordance with some exemplary embodiments, the at least one cell shaping beam may be created by at least one antenna of at least one radio access network device along the flight route of the aircraft.

In accordance with some exemplary embodiments, the at least one antenna may be an antenna with cell shaping capability and faces toward the sky.

In accordance with some exemplary embodiments, the at least one cell shaping beam may have a large angular spread for a direction along the flight route of the aircraft and a small angular spread for other directions.

In accordance with some exemplary embodiments, the method may further comprise receiving a request for a flight mission of the aircraft from the aircraft. The method may further comprise sending a response to the aircraft, wherein the response includes information regarding whether the aircraft traffic management device accepts the request.

In accordance with some exemplary embodiments, the method may further comprise sending a command for performing the flight mission to the aircraft.

In accordance with some exemplary embodiments, the method may further comprise sending a command to the OSS to shut down at least one apparatus related to at least one antenna of at least one radio access network device creating the at least one cell shaping beam.

In accordance with some exemplary embodiments, the aircraft may be an unmanned aerial vehicle or an aerial user equipment.

According to a second aspect of the present disclosure, there is provided an apparatus which may be implemented in or as an aircraft traffic management device. The apparatus comprises one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a computer program product comprising instructions which when executed by at least one processor, cause the at least one processor to perform any step of the method according to the first aspect of the present disclosure.

According to a fifth aspect of the present disclosure, there is provided an apparatus which may be implemented in or as an aircraft traffic management device. The apparatus comprises a determining unit and a sending unit. In accordance with some exemplary embodiments, the determining unit may be operable to carry out at least the determining step of the method according to the first aspect of the present disclosure. The sending unit may be operable to carry out the sending step of the method according to the first aspect of the present disclosure.

According to a sixth aspect of the present disclosure, there is provided a method performed by an operations support system. The method comprises receiving a request for creating at least one cell shaping beam for covering at least a part of a flight route of an aircraft from an aircraft traffic management device, wherein the request includes at least one cell shaping parameter. The method further comprises sending the request for creating at least one cell shaping beam for covering at least a part of the flight route of the aircraft to at least one radio access network device, wherein the at least one cell shaping parameter is determined based on cell information and a flight route of the aircraft.

In accordance with some exemplary embodiments, the flight route of the aircraft is determined based on at least one of position information regarding a flight mission of the aircraft, a service quality requirement of the aircraft, or the cell information.

In accordance with some exemplary embodiments, the method according to the sixth aspect of the present disclosure may further comprise receiving a command from the aircraft traffic management device to shut down at least one apparatus related to at least one antenna of the at least one radio access network device. The method may further comprises sending the command to the at least one radio access network device to shut down at least one apparatus related to at least one antenna of the at least one radio access network device.

According to a seventh aspect of the present disclosure, there is provided an apparatus which may be implemented in or as an operations support system. The apparatus comprises one or more processors and one or more memories storing computer program codes. The one or more memories and the computer program codes may be configured to, with the one or more processors, cause the apparatus at least to perform any step of the method according to the sixth aspect of the present disclosure.

According to an eighth aspect of the present disclosure, there is provided a computer-readable medium having computer program codes embodied thereon which, when executed on a computer, cause the computer to perform any step of the method according to the sixth aspect of the present disclosure.

According to a ninth aspect of the present disclosure, there is provided a computer program product comprising instructions which when executed by at least one processor, cause the at least one processor to perform any step of the method according to the sixth aspect of the present disclosure.

According to a tenth aspect of the present disclosure, there is provided an apparatus which may be implemented in or as an operations support system. The apparatus comprises a receiving unit and a sending unit. In accordance with some exemplary embodiments, the receiving unit may be operable to carry out at least the receiving step of the method according to the sixth aspect of the present disclosure. The sending unit may be operable to carry out at least the sending step of the method according to the sixth aspect of the present disclosure.

According to an eleventh aspect of the present disclosure, there is provided a method performed by a radio access network device. The method comprises receiving a request for creating a cell shaping beam for covering at least a part of a flight route of an aircraft from an operations support system. The request includes at least one cell shaping parameter. The method further comprises creating the cell shaping beam for covering at least a part of the flight route of the aircraft based on the at least one cell shaping parameter. The at least one cell shaping parameter is determined based on cell information and a flight route of the aircraft.

In accordance with some exemplary embodiments, the flight route of the aircraft is determined based on at least one of position information regarding a flight mission of the aircraft, a service quality requirement of the aircraft, or the cell information.

In accordance with some exemplary embodiments, the radio access network device is along the flight route of the aircraft.

In accordance with some exemplary embodiments, the method according to the eleventh aspect of the present disclosure may further comprise receiving a command from the operations support system to shut down at least one apparatus related to at least one antenna of the radio access network device. The method may further comprise shutting down the at least one apparatus related to at least one antenna of the radio access network device based on the command.

According to a twelfth aspect of the present disclosure, there is provided an apparatus which may be implemented in or as a radio access network device. The apparatus comprises one or more processors and one or more memories storing computer program codes. The one or more memories and the computer program codes may be configured to, with the one or more processors, cause the apparatus at least to perform any step of the method according to the eleventh aspect of the present disclosure.

According to a thirteenth aspect of the present disclosure, there is provided a computer-readable medium having computer program codes embodied thereon which, when executed on a computer, cause the computer to perform any step of the method according to the eleventh aspect of the present disclosure.

According to a fourteenth aspect of the present disclosure, there is provided a computer program product comprising instructions which when executed by at least one processor, cause the at least one processor to perform any step of the method according to the eleventh aspect of the present disclosure.

According to a fifteenth aspect of the present disclosure, there is provided an apparatus which may be implemented in or as a radio access network device. The apparatus comprises a receiving unit and a creating unit. In accordance with some exemplary embodiments, the receiving unit may be operable to carry out at least the receiving step of the method according to the eleventh aspect of the present disclosure. The creating unit may be operable to carry out at least the creating step of the method according to the eleventh aspect of the present disclosure.

According to a sixteenth aspect of the present disclosure, there is provided a method performed by an aircraft. The method comprises determining to perform a flight mission along a flight route. The method further comprises performing the flight mission along the flight route. The at least one cell shaping beam is created for covering at least a part of the flight route of the aircraft.

In accordance with some exemplary embodiments, the method according to the sixteenth aspect of the present disclosure may further comprise sending a request for the flight mission to an aircraft traffic management device. The method may further comprise receiving a response from the aircraft traffic management device, wherein the response includes information regarding whether the aircraft traffic management device accepts the request. Determining to perform the flight mission along the flight route may be in response to receiving a positive response from the aircraft traffic management device.

In accordance with some exemplary embodiments, the method according to the sixteenth aspect of the present disclosure may further comprise receiving a command for performing the flight mission from the aircraft traffic management device. Determining to perform the flight mission along the flight route may be in response to receiving the command for performing the flight mission from the aircraft traffic management device.

According to a seventeenth aspect of the present disclosure, there is provided an apparatus which may be implemented in or as aircraft. The apparatus comprises one or more processors and one or more memories storing computer program codes. The one or more memories and the computer program codes may be configured to, with the one or more processors, cause the apparatus at least to perform any step of the method according to the sixteenth aspect of the present disclosure.

According to an eighteenth aspect of the present disclosure, there is provided a computer-readable medium having computer program codes embodied thereon which, when executed on a computer, cause the computer to perform any step of the method according to the sixteenth aspect of the present disclosure.

According to a nineteenth aspect of the present disclosure, there is provided a computer program product comprising instructions which when executed by at least one processor, cause the at least one processor to perform any step of the method according to the sixteenth aspect of the present disclosure.

According to a twentieth aspect of the present disclosure, there is provided an apparatus which may be implemented in or as an aircraft. The apparatus comprises a determining unit and a performing unit. In accordance with some exemplary embodiments, the determining unit may be operable to carry out at least the determining step of the method according to the sixteenth aspect of the present disclosure. The performing unit may be operable to carry out at least the performing step of the method according to the sixteenth aspect of the present disclosure.

Embodiments herein afford many advantages, of which a non-exhaustive list of examples follows. Some embodiments herein may provide a cost efficient aerial coverage scheme, which can save more cost than conventional flight route coverage scheme. Some embodiments herein may require less neighbor cells and less handover. In some embodiments herein, the cells for aerial coverage can be shut down by the aircraft traffic management device such as UTM when there is no drone flight mission, which can reduce DL (downlink)/UL (uplink) interference to terrestrial users and save energy. In some embodiments herein, the emitted power of the radio access network device may be concentrated to a small area by cell shaping, which can increase the signal quality for the aerial coverage, increase aerial coverage distance and reduce cost. In some embodiments herein, the antennas can create different appropriate cell shaping beams for different flight route coverage. The embodiments herein are not limited to the features and advantages mentioned above. A person skilled in the art will recognize additional features and advantages upon reading the following detailed description.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 schematically shows LOS/NLOS (non-LOS) propagation for aerial and ground-based devices;

FIG. 2 shows distance to detected and serving cells;

FIG. 3 schematically shows geometry signal-to-interference ratio (SIR) pattern at different heights;

FIG. 4 schematically shows a radiation pattern of an antenna device;

FIG. 5 schematically shows how the vertical pattern becomes more and more directive when several antenna elements are stacked in the vertical plane;

FIG. 6 schematically shows the cell association patterns based on maximum received power;

FIG. 7 shows a simulated result of measurements of the signal strengths of the cells;

FIG. 8 schematically shows an example of flight route coverage of an aircraft by using a conventional cell pattern of a cellular antenna;

FIG. 9 schematically shows an example of high-rise cell shaping;

FIG. 10 schematically shows an example of macro cell shaping;

FIG. 11 is a flowchart illustrating a method according to an embodiment of the present disclosure;

FIG. 12 is a flowchart illustrating a method according to another embodiment of the present disclosure;

FIG. 13 is a flowchart illustrating a method according to another embodiment of the present disclosure;

FIG. 14 is a flowchart illustrating a method according to another embodiment of the present disclosure;

FIG. 15 is a flowchart illustrating a method according to another embodiment of the present disclosure;

FIG. 16 is a flowchart illustrating a method according to another embodiment of the present disclosure;

FIG. 17 is a flowchart illustrating a method according to another embodiment of the present disclosure;

FIG. 18 is a flowchart illustrating a method according to another embodiment of the present disclosure;

FIG. 19 is a flowchart illustrating a method according to another embodiment of the present disclosure;

FIG. 20 schematically shows an example of how the proposed solution works according to an embodiment of the present disclosure;

FIG. 21 schematically shows an example of how the proposed solution works according to another embodiment of the present disclosure;

FIG. 22 schematically shows an example of cell shaping;

FIG. 23 schematically shows an example of flight routes according to an embodiment of the present disclosure;

FIG. 24 schematically shows “L” shape of cell;

FIG. 25 is a block diagram illustrating an apparatus according to some embodiments of the present disclosure;

FIG. 26 is a block diagram illustrating a telecommunication network connected via an intermediate network to a host computer in accordance with some embodiments of the present disclosure;

FIG. 27 is a block diagram illustrating a host computer communicating via a base station with a UE over a partially wireless connection in accordance with some embodiments of the present disclosure;

FIG. 28 is a flowchart illustrating a method implemented in a communication system, in accordance with an embodiment of the present disclosure;

FIG. 29 is a flowchart illustrating a method implemented in a communication system, in accordance with an embodiment of the present disclosure;

FIG. 30 is a flowchart illustrating a method implemented in a communication system, in accordance with an embodiment of the present disclosure; and

FIG. 31 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable wireless communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3rd Generation Partnership Project (3GPP). For example, the communication protocols as may comprise the first generation (1G), 2G, 3G, 4G, 4.5G, 5G communication protocols, and/or any other protocols either currently known or to be developed in the future.

The term “network device” refers to a network node in a communication network via which a terminal device accesses to the network and receives services therefrom. The network device may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), an integrated access backhaul (IAB) node, a relay, a low power node such as a femto, a pico, and so forth.

Yet further examples of the network device comprises multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, an unmanned aerial vehicle, an aerial user equipment, or other suitable devices. The terminal device may include, but not limited to, a portable computer, an image capture device such as a digital camera, a gaining terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable device, a vehicle-mounted wireless device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a UE may represent a terminal device configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a UE may be configured to transmit and/or receive information without direct human interaction. For instance, a UE may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

As yet another specific example, in an IoT scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3GPP context be referred to as a machine-type communication (MTC) device. An aerial UE refers to any UE in the air.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, a downlink, DL, transmission refers to a transmission from a network device to a terminal device, and an uplink, UL, transmission refers to a transmission in an opposite direction.

As used herein, an aircraft refers to any machine supported for flight in the air by buoyancy or by the dynamic action of air on its surfaces. By way of example and not limitation, the aircraft may include, but not limited to, aerial vehicle such as Unmanned Aerial Vehicle (UAV), aerial UE, powered airplanes, gliders, helicopters, drones, balloons, and so forth.

As used herein, Unmanned Aircraft System (UAS) Traffic Management (UTM) system refers to a system which can provide various functions such as defining the rules of aircraft (such as drone) operation, addressing the safety issues for aircraft such as drone, etc. For example, the functions of the UTM may include mandating drone traffic management systems similar to the air traffic control systems of manned aviation. Aerial flight route may be planned by UTM. UTM can communicate with cellular networks by a northbound interface of operations support system (OS S).

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to LTE or NR network being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

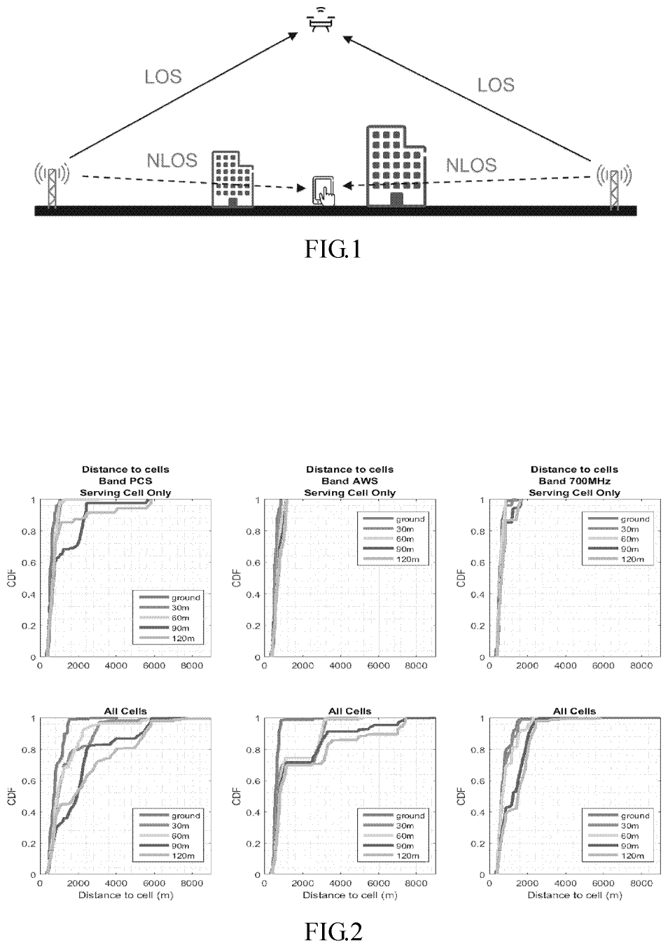

As described above, several challenges that lead to a different radio environment at a higher altitude may be LOS propagation/uplink interference, poor KPI caused by antenna sidelobes, sudden drop in signal strength, etc. These challenges will be described in detail with reference to FIGS. 1-8.

FIG. 1 schematically shows LOS/NLOS (non-LOS) propagation for aerial and ground-based devices. Empirical measurements have shown that aerial radio channels exhibit different propagation characteristics compared to the terrestrial radio channels. One distinct feature of the aerial radio channels is the higher likelihood of LOS propagation due to the absence of obstacles in the sky as illustrated in FIG. 1. Aircrafts such as drones flying in the sky may be served by beams propagate with LOS. The LOS propagation becomes closer to free space transmission and its path loss is very low. The received signal strengths of the aircrafts may be very strong even the aircrafts are far away from the serving radio access network device such as base station. This fact has been verified by field measurements in 3GPP TR 36.777 V15.0.0, the disclosure of which is incorporated by reference herein in its entirety.

FIG. 2 shows distance to detected and serving cells, which is a copy of Figure H.1.3-1 of 3GPP TR 36.777 V15.0.0. As shown in FIG. 2, the aerial UE on altitude 120 m are served by base station as far as 6 km, and up to 8 km distances are observed for neighbor cells. If the altitude is 300 meters (m), the distance may be about 20 km. So for flight route coverage for example on 300 m or above, for example, deployment of a few up-tilted (e.g., 90 degrees) antennas with large angular spread and high ISD (inter sector distance, e.g. 40 km) can actually meet the request for flight route coverage on 300 m with low cost.

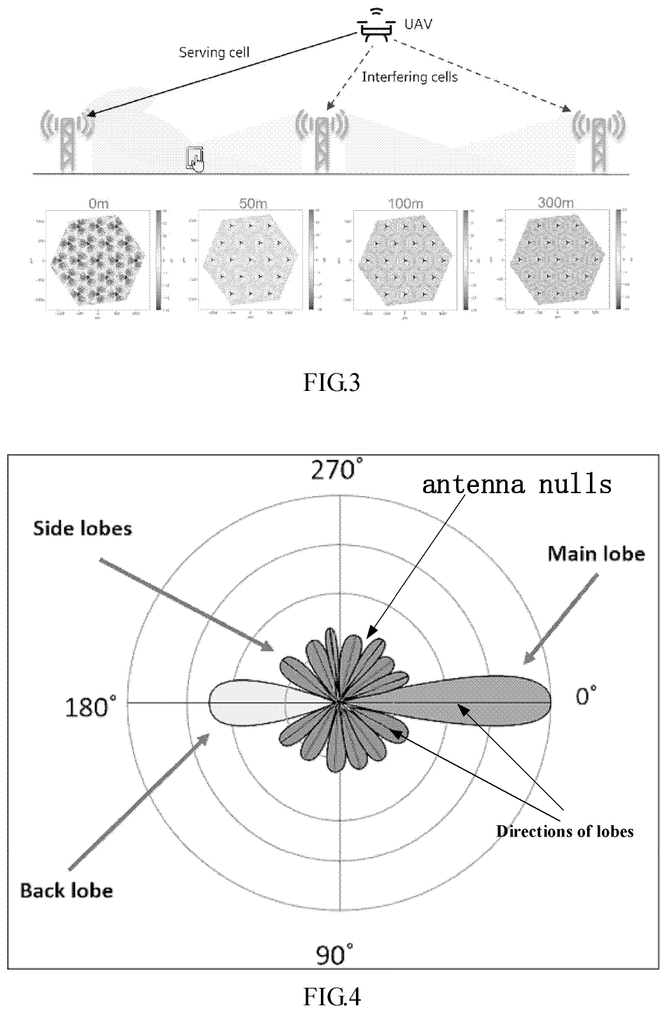

FIG. 3 schematically shows geometry signal-to-interference ratio (SIR) pattern at different heights. As shown in FIG. 3, the UAV experiencing LOS propagation conditions from many neighbor cells that cause comparably high interference levels may have difficulty in establishing and maintaining connection to the network. Since the signal propagation in the sky is close to LOS, the signal strength becomes stronger due to the reduced path loss. The stronger signal strength from the serving base station is desirable. The UAV, however, may have LOS paths to many non-serving base stations in the area as well. Since the serving cell and interfering cells may share the same radio resources, the increased likelihood of LOS paths to many non-serving cells increases the interference for the UAV. The high level of interference might cause a low signal-to-interference-plus-noise ratio (SINR), which might make it difficult for the aerial UE to promptly receive and decode mobility management related messages (for example, handover commands). As many use cases require UAVs to transmit video feeds to their flight controllers, which imposes heavy uplink traffic load on the network, so UAV may generate more uplink interference to the network. As shown in FIG. 3, at the height of Om, there is almost no interference from neighbor cells, while with the increase of height (such as 50 m, 100 m and 300 m), there are more or more interference from neighbor cells. So the UAVs experiencing LOS propagation conditions to many neighbor cells that cause comparably high interference levels may have difficulty in establishing and maintaining connection to the network.

Another effect making the radio environment in the sky different from that on the ground is due to the sidelobes of antenna. Every directional antenna emits radiation also in unwanted directions, known as sidelobes.

FIG. 4 schematically shows a radiation pattern of an antenna device. The radiation pattern of the antenna device shows a pattern of “lobes” at various angles and directions where the radiated signal strength reaches a maximum. The lobes are separated by “nulls” at angles and directions where the radiated signal strength falls to zero. In a directional antenna in which the objective is to emit the radio waves in one direction, the lobe in that direction may be designed to have a larger field strength than the others. This lobe may be referred to as “main lobe”. The other lobes may be referred to as “side lobes”, and usually represent unwanted radiation in undesired directions. A side lobe in the opposite direction (180°) from the main lobe is called the back lobe. Different antenna configuration may have different number of side lobes and different angular coverage area (steering range). Traditional directional antenna has a reflector to remove the back lobe and concentrate energy in the direction of main lobe for antenna gain.

FIG. 5 schematically shows how the vertical pattern becomes more and more directive when several antenna elements are stacked in the vertical plane. It can also see the sidelobes that appear due to the finite antenna size.

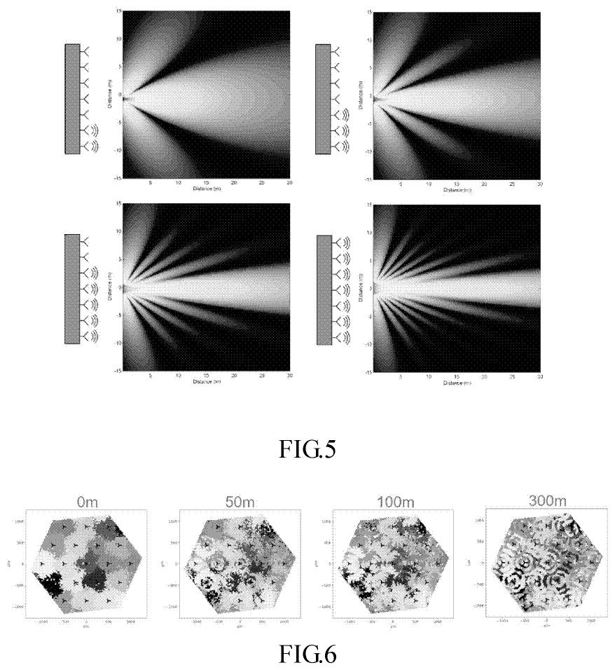

FIG. 6 schematically shows the cell association patterns based on maximum received power at ground level (i.e., height of Om), and heights of 50 m, 100 m, and 300 m in a simulated rural macro LTE network. The existing mobile networks are optimized for terrestrial broadband communication with the antennas of base stations being down-tilted to optimize the ground coverage and reduce the inter-cell interference. A terrestrial UE is usually served by the main lobe of the base station antenna. With down-titled base station antennas, aircrafts such as drones flying in the sky may be served by the sidelobes of base station antennas that have smaller antenna gains than the main lobe antenna gains. However, the higher likelihood of LOS propagation can make up for antenna gain reductions, and in some scenarios may lead to even stronger received signal strengths. The sidelobes give rise to the phenomenon of scattered cell associations particularly noticeable in the sky. The UE cell association may be based on strongest received signal power, i.e., each position is associated with the cell from which the strongest signal is received at that position.

As shown in FIG. 6, it can be seen that the cell association patterns change dramatically with height. The cell association pattern on the ground is ideally a nicely defined and contiguous area where the best cell is most often the one closest to the UE. As moving up in height, the antenna's side lobes start to be visible, and the best cell may no longer be the closest cell. The cell association pattern in this particular scenario becomes fragmented especially at a height of 300 m and above. The cell association pattern as shown in FIG. 6 only represents a specific scenario. The association pattern may depend on deployment parameters such as inter-site distance, antenna patterns, antenna height, and down-tilt angles of the antennas of the base station antenna. In general, the cell association patterns in the sky are quite different from the association patterns on the ground. The fragmented cell association pattern itself is not necessarily a problem. However, a drone UE served by a sidelobe might experience very sharp drops in signal strength when moving in the sky.

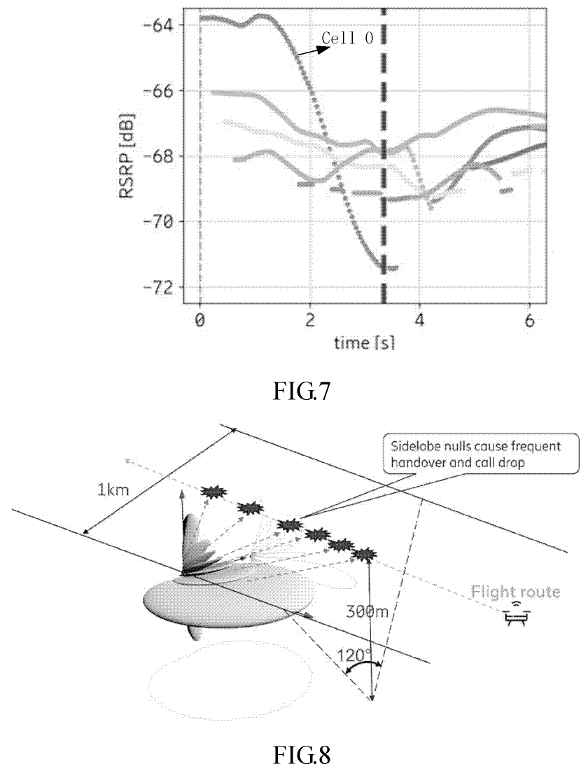

FIG. 7 shows a simulated result of measurements of the signal strengths (e.g., Reference Signal Received Power (RSRP)) of the cells. As shown in FIG. 7, at the beginning of the simulation (marked by a fine dashed vertical line), the aircraft such as drone selects cell 0 as the serving cell. After a few seconds, the signal strength of cell 0 begins to drop rapidly, and before the aircraft can be handed over to another cell, it declares radio link failure at the time instant marked by the thick dashed line. Therefore when the aircraft such as drone moves through the sidelobe nulls of base station antennas, the default mobility procedures might be too slow for successful execution.

With conventional solution, operators may have to deploy up-tilted antenna for aerial coverage. Cellular networks are primarily optimized for users on the ground and inside buildings. For seamless aerial coverage (e.g., 300 m or above), the requested number of base stations may be about several times as that of terrestrial coverage. It may be impossible for operators to deploy such a big network for drone application only.

FIG. 8 schematically shows an example of flight route coverage of an aircraft by using a conventional cell pattern of a cellular antenna. As shown in FIG. 8, for cellular antennas, there is big angular spread in azimuth domain, which means aircrafts on a flight route may not use the full potential of azimuth beam steering, most of power of the main lobe and the side lobes may be wasted for flight route coverage scenario (for example, the coverage width of cellular antennas can reach about 1 km on 300 m for 120° azimuth spread). In addition, there are many sidelobe nulls in polar domain to degrade performance (e.g., frequent handover, call drop due to sudden drop in signal strength) on the flight route.

To overcome or mitigate at least one above mentioned problem or other problems, the embodiments of the present disclosure propose an improved aircraft traffic management by means of cell shaping.

In NR/LTE multiple antenna system, common antenna to port mapping weights are needed for basic data transfer, i.e., the common beamforming weights. Advanced antenna arrays can be used to form cell specific antenna patterns. Cell shaping can be static or dynamic, to shaping the cell to suit the current traffic distribution and load. Cell shaping may improve system performance, i.e., coverage and capacity through cell isolation and/or load balancing. The absolute gain of cell shaping may be depended on scenario. Conventional application scenarios for cell shaping may include high-rise cell shaping, macro cell shaping, etc.

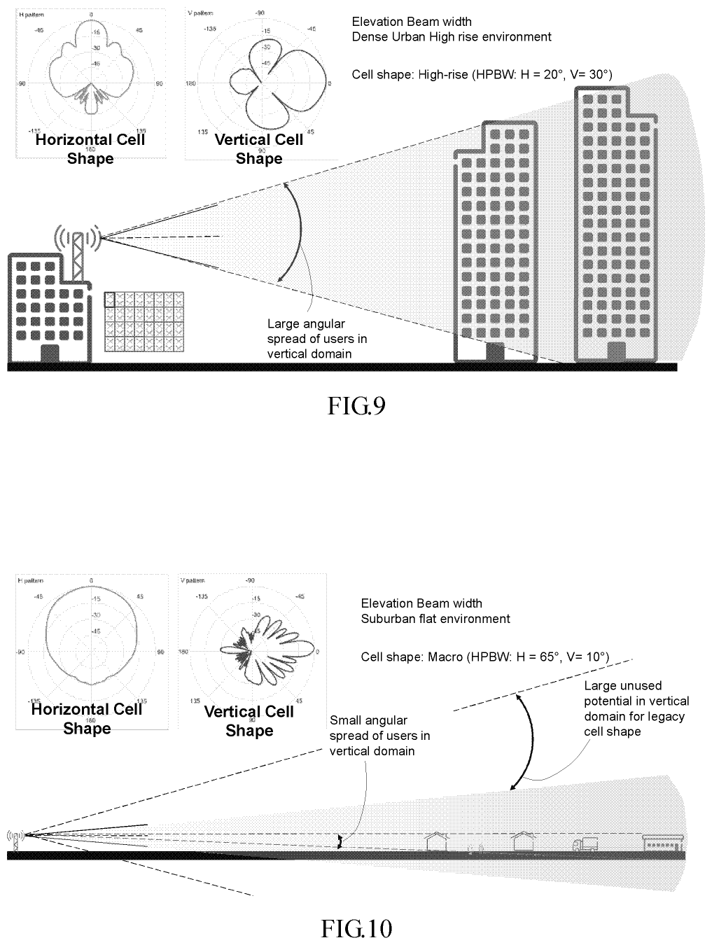

High-rise cell shaping is a cell shaping which may be used for UE distribution in dense urban environment with high buildings. FIG. 9 schematically shows an example of high-rise cell shaping. HPBW denotes Half Power Beam Width. H denotes horizontal. V denotes vertical. As shown in FIG. 9, high-rise cell shaping has a small angular spread of users in horizontal domain but a large angular spread in vertical domain.

Marco cell shaping is a cell shaping which may be used for UE distribution in suburban flat environment. FIG. 10 schematically shows an example of macro cell shaping. As shown in FIG. 10, macro cell shaping has a small angular spread of users in vertical domain but a large angular spread in horizontal domain. Marco cell shaping can cover more than 120 degrees.

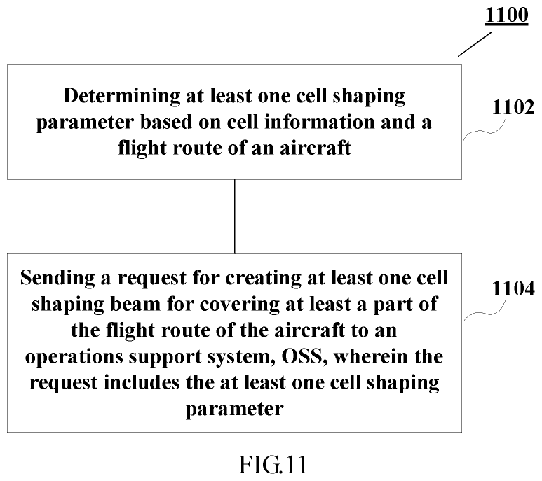

FIG. 11 is a flowchart illustrating a method 1100 according to an embodiment of the present disclosure. The method 1100 illustrated in FIG. 11 may be performed by an aircraft traffic management device or an apparatus communicatively coupled to the aircraft traffic management device. As such, the aircraft traffic management device may provide means or modules for accomplishing various parts of the method 1100 as well as means or modules for accomplishing other processes in conjunction with other components.

The aircraft traffic management device may support a wide variety of aerial devices such as aircrafts or aerial user equipments. For example, the aircrafts may include manned aerial systems and unmanned aerial systems (UAS) such as drone. The aerial user equipment may include various terminal devices as described above which are used in the sky. The input to the aircraft traffic management device may include: UAV mission/business flight plan or trajectory, real-time weather and wind, predicted wind and weather, airspace constraints (dynamically adjusted), community needs about sensitive areas (dynamically adjusted), three-dimensional maps that include man-made structures as well as natural terrain, etc. The aircraft traffic management device may need persistent communication, navigation, and surveillance coverage. The aircraft traffic management device may provide authentication, airspace design, airspace corridors, and dynamic geofencing, weather integration, constraint management (congestion prediction), sequencing and spacing as needed, trajectory changes to ensure safety, contingency management, separation management, transition locations, and geo-fencing design and dynamic adjustments, etc.

In an embodiment, the aircraft traffic management device may be or belong to Unmanned Aircraft System Traffic Management (UTM) system as defined by the Federal Aviation Administration (FAA) and National Aeronautics and Space Administration (NASA). Such UTM system may be used to manage the traffic of UAVs as an enabler to promote its wide spread use in commercial and recreational settings while at the same time minimizing/reducing the perils to commercial air traffic and other surrounding critical infrastructure. The UTM system may be designed to work autonomously (i.e., with no active human air traffic controller constantly supervising and monitoring the airspace). Specification work for the architecture is ongoing, and led by NASA.

At block 1102, the aircraft traffic management device determines at least one cell shaping parameter based on cell information and a flight route of an aircraft.

The cell herein may refer to a cell of a wireless communication network. For example, the cell may be a cell of a cellular network such as 3GPP-type cellular network. The cell information may include any suitable information related to the cell. In an embodiment, the cell information may include at least one of aerial coverage capability of a cell, a coverage area of a cell, a load of a cell, an antenna orientation of a cell, or a cell shaping state of a cell. The aircraft traffic management device may obtain the cell information from a network management device by sending a request to the network management device. In addition, the network management device may push the cell information to the aircraft traffic management device when there is a change in the cell information.

In an embodiment, the flight route of the aircraft may be obtained from the aircraft or a device assigning a flight mission to the aircraft. In another embodiment, the flight route of the aircraft may be determined by the aircraft traffic management device for example based on at least one of position information regarding a flight mission of the aircraft, a service quality requirement of the aircraft, or the cell information. The position information of the flight mission of the aircraft may include various position information of the flight mission, such as at least one of a start position, at least one position that the aircraft is required to be passed, and an end position of the flight mission of the aircraft. The service quality requirement of the aircraft may include any suitable service quality requirement for the flight mission of the aircraft, such as a length limit of flight route, a time limit for finishing the flight mission, one or more specified positions that the aircraft needs to pass, a flight height requirement of the flight mission, a communication availability requirement of the flight mission, security requirement of the flight mission, etc.

As an example, when a drone flight mission is from point a to point b and there is one or more candidate flight routes from point A to point B, the aircraft traffic management device may determine one flight route from the one or more candidate flight route based on at least one of position information regarding a flight mission of the aircraft, a service quality requirement of the aircraft, or the cell information. For example, when the drone flight mission requires that the drone should pass point c, the aircraft traffic management device may select the flight route that includes point c. When the drone flight mission requires that the length of the flight route is less than k meters, the aircraft traffic management device may select the flight route whose length is less than k meters. When the drone flight mission requires high communication availability (for example, the aircraft on any points on the flight route can communicate with the aircraft traffic management device), the aircraft traffic management device may select the flight route having high communication availability. When the drone flight mission requires high security, the aircraft traffic management device may select the flight route having high security.

The aircraft traffic management device may consider aerial coverage capability of a cell to select a radio access network device able to cover at least a part of the flight route. The aircraft traffic management device may consider a coverage area of a cell to select a radio access network device whose coverage area can cover a part of the flight route. When the drone flight mission requires high service quality requirement, the aircraft traffic management device may consider a load of a cell to select a radio access network device with a low load of a cell. The aircraft traffic management device may also consider an antenna orientation of a cell and/or a cell shaping state of a cell to select the radio access network device to cover at least a part of the flight route.

When the aircraft traffic management device knows the cell information and the flight route of the aircraft, the aircraft traffic management device may determine at least one cell shaping parameter based on cell information and the flight route of an aircraft. For example, the aircraft traffic management device may determine one or more radio access network device which can cover at least a part of the flight route of the aircraft. For each of the one or more radio access network device, the aircraft traffic management device may determine a cell shape to cover a part of the flight route of the aircraft and then determine at least one cell shaping parameter for creating the cell shape.

In an embodiment, when there are two or more flight missions and there is a common flight route of the two or more flight missions which can be served by a radio access network device, the aircraft traffic management device may determine at least one cell shaping parameter for the radio access network device to cover the common flight route. The common flight route may be overlapped or under the coverage of radio access network device.

At block 1104, the aircraft traffic management device sends a request for creating at least one cell shaping beam for covering at least a part of the flight route of the aircraft to an operations support system (OSS). The request includes the at least one cell shaping parameter. OSS may be a computer system used by telecommunications service providers to manage their networks (e.g., wireless communication network). OSS may support management functions such as network inventory, service provisioning, network configuration and fault management, etc.

The at least a part of the flight route of the aircraft may include all the flight route of the aircraft or a part of the flight route of the aircraft. The at least one cell shaping parameter may be used to creating at least one cell shaping beam for covering all the flight route of the aircraft or a part of the flight route of the aircraft. For example, when some route(s) of the flight route of the aircraft has been covered by one or more radio access network devices, the aircraft traffic management device may not determine cell shaping parameter for those radio access network devices. When some route(s) of the flight route of the aircraft is not required to be covered by one or more radio access network devices (for example, the aircraft does not require communication on one or more specified flight route segments), the aircraft traffic management device may not determine cell shaping parameter for those radio access network devices. When some route(s) of the flight route of the aircraft is required to be covered by one or more radio access network devices, the aircraft traffic management device may determine cell shaping parameter for those radio access network devices. At least one cell shaping parameter used for a radio access network device may be associated with an identifier of the radio access network device or other identifier which can be identified by the OSS.

In an embodiment, the at least one cell shaping beam may be created by at least one antenna of at least one radio access network device along the flight route of the aircraft. In other embodiments, the at least one cell shaping beam may be created by at least one antenna of at least one radio access network device close to the flight route of the aircraft.

In an embodiment, the at least one antenna for creating the at least one cell shaping beam is an antenna with cell shaping capability and faces toward the sky. For example, the antenna with cell shaping capability may be installed up-tiled with 90 degrees.

In an embodiment, the at least one cell shaping beam may have a large angular spread for a direction along the flight route of the aircraft and a small angular spread for other directions.

In an embodiment, the aircraft may be an unmanned aerial vehicle or an aerial user equipment.

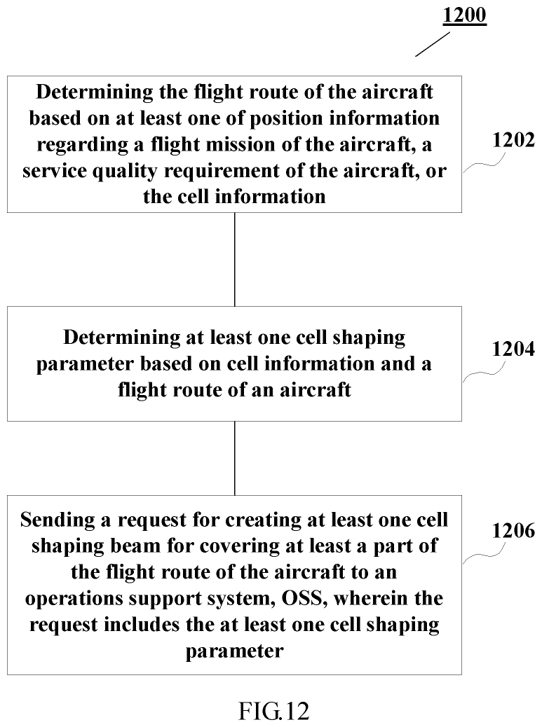

FIG. 12 is a flowchart illustrating a method 1200 according to an embodiment of the present disclosure. The method 1200 illustrated in FIG. 12 may be performed by an aircraft traffic management device or an apparatus communicatively coupled to the aircraft traffic management device. As such, the aircraft traffic management device may provide means or modules for accomplishing various parts of the method 1200 as well as means or modules for accomplishing other processes in conjunction with other components. For some parts which have been described in the above embodiments, the description thereof is omitted here for brevity.

At block 1202, the aircraft traffic management device determines the flight route of the aircraft based on at least one of position information regarding a flight mission of the aircraft, a service quality requirement of the aircraft, or the cell information as described above.

At block 1204, the aircraft traffic management device determines at least one cell shaping parameter based on cell information and a flight route of an aircraft. Block 1204 is similar to block 1102.

At block 1206, the aircraft traffic management device sends a request for creating at least one cell shaping beam for covering at least a part of the flight route of the aircraft to an operations support system (OSS), wherein the request includes the at least one cell shaping parameter. Block 1206 is similar to block 1104.

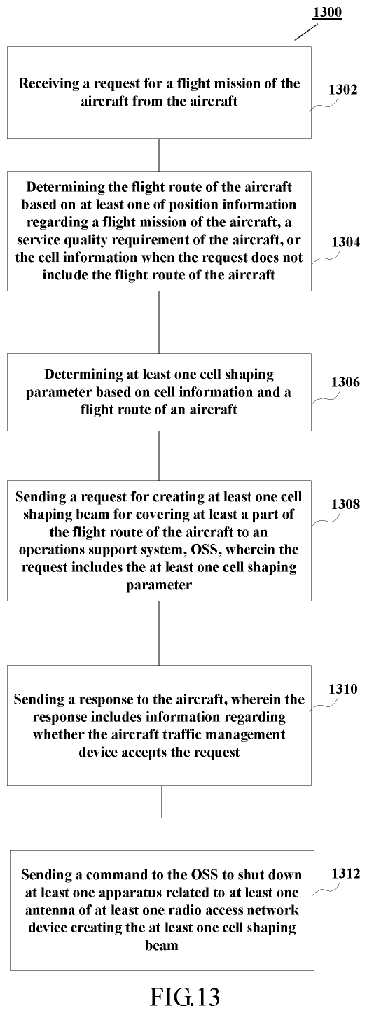

FIG. 13 is a flowchart illustrating a method 1300 according to an embodiment of the present disclosure. The method 1300 illustrated in FIG. 13 may be performed by an aircraft traffic management device or an apparatus communicatively coupled to the aircraft traffic management device. As such, the aircraft traffic management device may provide means or modules for accomplishing various parts of the method 1300 as well as means or modules for accomplishing other processes in conjunction with other components. For some parts which have been described in the above embodiments, the description thereof is omitted here for brevity. In this embodiment, the aircraft actively requests to perform a flight mission and sends the request to the aircraft traffic management device.

At block 1302, the aircraft traffic management device receives a request for a flight mission of the aircraft from the aircraft. In an embodiment, the request may include the flight route of the aircraft. In another embodiment, the request may include the position information regarding a flight mission of the aircraft and/or a service quality requirement of the aircraft.

At block 1304, the aircraft traffic management device determines the flight route of the aircraft based on at least one of position information regarding a flight mission of the aircraft, a service quality requirement of the aircraft, or the cell information when the request does not include the flight route of the aircraft. Block 1304 is similar to block 1202 of FIG. 12.

At block 1306, the aircraft traffic management device determines at least one cell shaping parameter based on cell information and a flight route of an aircraft. Block 1306 is similar to block 1102 of FIG. 11.

At block 1308, the aircraft traffic management device sends a request for creating at least one cell shaping beam for covering at least a part of the flight route of the aircraft to an operations support system (OSS), wherein the request includes the at least one cell shaping parameter. Block 1308 is similar to block 1104 of FIG. 11.

At block 1310, the aircraft traffic management device sends a response to the aircraft. The response may include information regarding whether the aircraft traffic management device accepts the request. For example, the aircraft traffic management device may not accept the request due to various reasons such as authentication failure of the aircraft, no suitable flight route, no-fly list, no-fly zone, unflyable weather, etc. Then the aircraft traffic management device may send a response to the aircraft to notify that the flight mission can not be performed and may include the detailed reason in the response. In this case, block 1310 may be performed between block 1302 and block 1304. When the aircraft traffic management device accepts the request, the aircraft traffic management device may send a response to the aircraft to notify that the flight mission can be performed and may include the flight route of the aircraft and the flight start time in the response when the flight route of the aircraft is determined by the aircraft traffic management device. In this case, block 1310 may be performed after block 1308.

At block 1312, the aircraft traffic management device sends a command to the OSS to shut down at least one apparatus related to at least one antenna of at least one radio access network device creating the at least one cell shaping beam. This command can be sent to a radio access network device at any suitable time point, for example, when the aircraft flies away from the cell shaping beam created by the antenna of the radio access network device or when the flight mission is finished. When there are two or more flight missions served by a radio access network device, the command can be sent to the radio access network device when all the aircrafts related to two or more flight mission fly away from the cell shaping beam created by the antenna of the radio access network device or when the two or more flight missions are finished.

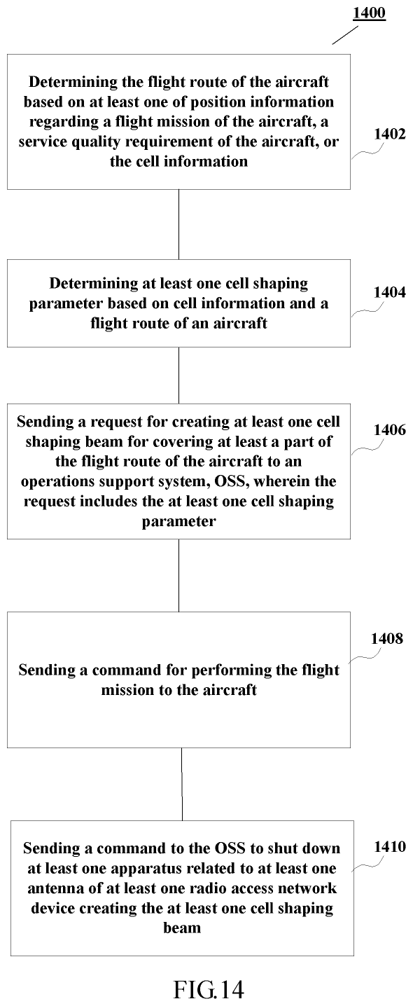

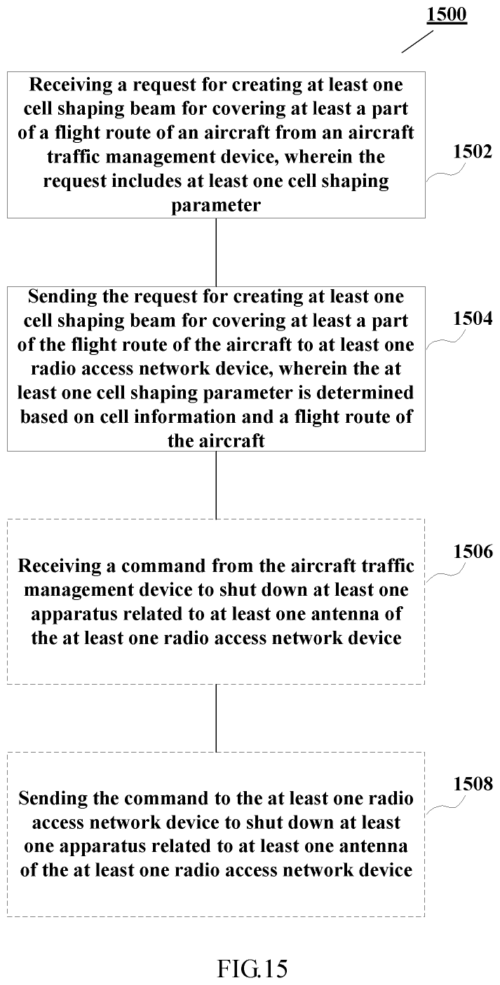

FIG. 14 is a flowchart illustrating a method 1400 according to an embodiment of the present disclosure. The method 1400 illustrated in FIG. 14 may be performed by an aircraft traffic management device or an apparatus communicatively coupled to the aircraft traffic management device. As such, the aircraft traffic management device may provide means or modules for accomplishing various parts of the method 1400 as well as means or modules for accomplishing other processes in conjunction with other components. For some parts which have been described in the above embodiments, the description thereof is omitted here for brevity. In this embodiment, the aircraft traffic management device may actively instruct the aircraft to perform a flight mission without the request from the aircraft.

At block 1402, the aircraft traffic management device determines the flight route of the aircraft based on at least one of position information regarding a flight mission of the aircraft, a service quality requirement of the aircraft, or the cell information. Block 1402 is similar to block 1202 of FIG. 12.

At block 1404, the aircraft traffic management device determines at least one cell shaping parameter based on cell information and a flight route of an aircraft. Block 1404 is similar to block 1102 of FIG. 11.

At block 1406, the aircraft traffic management device sends a request for creating at least one cell shaping beam for covering at least a part of the flight route of the aircraft to an operations support system, OSS, wherein the request includes the at least one cell shaping parameter. Block 1406 is similar to block 1104 of FIG. 11.

At block 1408, the aircraft traffic management device sends a command for performing the flight mission to the aircraft. The aircraft traffic management device may send the command to the aircraft to notify that the flight mission should be performed and may include the flight route of the aircraft and the flight start time in the command.

At block 1410, the aircraft traffic management device sends a command to the OSS to shut down at least one apparatus related to at least one antenna of at least one radio access network device creating the at least one cell shaping beam. Block 1410 is similar to block 1312 of FIG. 13.

FIG. 15 is a flowchart illustrating a method 1500 according to an embodiment of the present disclosure. The method 1500 illustrated in FIG. 15 may be performed by an operations support system or an apparatus communicatively coupled to the operations support system. As such, the operations support system may provide means or modules for accomplishing various parts of the method 1500 as well as means or modules for accomplishing other processes in conjunction with other components. For some parts which have been described in the above embodiments, the description thereof is omitted here for brevity.

At block 1502, the operations support system receives a request for creating at least one cell shaping beam for covering at least a part of a flight route of an aircraft from an aircraft traffic management device. The request includes at least one cell shaping parameter. For example, the aircraft traffic management device may send the request to the OSS at block 1104 of FIG. 11, and then the OSS may receive this request. As described above, the flight route of the aircraft may be determined based on at least one of position information regarding a flight mission of the aircraft, a service quality requirement of the aircraft, or the cell information. The position information of the flight mission of the aircraft may include a start position and an end position of the flight mission of the aircraft. The cell information includes at least one of aerial coverage capability of a cell; a coverage area of a cell; an antenna orientation of a cell; or a cell shaping state of a cell. The at least one radio access network device may be along the flight route of the aircraft. The aircraft may be an unmanned aerial vehicle or an aerial user equipment. The cell shaping beam may have a large angular spread for a direction along the flight route of the aircraft and a small angular spread for other directions.

At block 1504, the operations support system sends the request for creating at least one cell shaping beam for covering at least a part of the flight route of the aircraft to at least one radio access network device. For example, as described above, at least one cell shaping parameter used for a radio access network device may be associated with an identifier of the radio access network device or other identifier which can be identified by the OSS, and then the OSS can send the request for creating a cell shaping beam for covering at least a part of the flight route of the aircraft to a corresponding radio access network device.

At block 1506, optionally, the operations support system receives a command from the aircraft traffic management device to shut down at least one apparatus related to at least one antenna of the at least one radio access network device. For example, the aircraft traffic management device may send this command at block 1312 of FIG. 13, and then the operations support system may receive the command from the aircraft traffic management device.

At block 1508, optionally, the operations support system sends the command to the at least one radio access network device to shut down at least one apparatus related to at least one antenna of the at least one radio access network device.

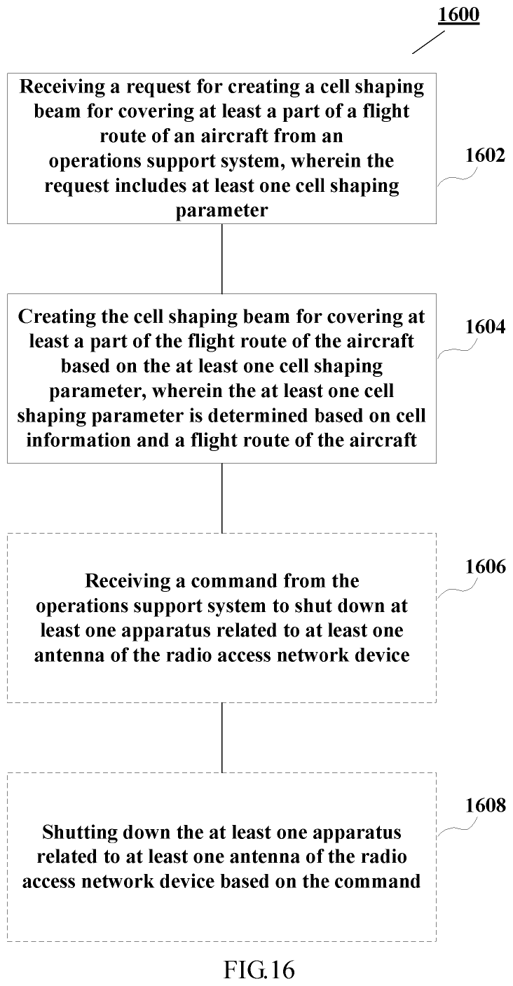

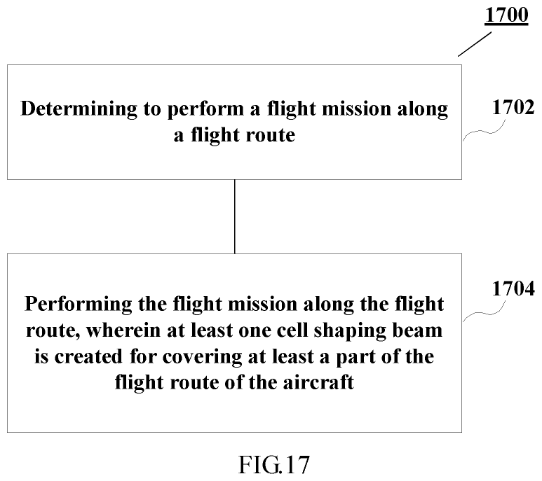

FIG. 16 is a flowchart illustrating a method 1600 according to an embodiment of the present disclosure. The method 1600 illustrated in FIG. 16 may be performed by a radio access network device or an apparatus communicatively coupled to the radio access network device. As such, the radio access network device may provide means or modules for accomplishing various parts of the method 1600 as well as means or modules for accomplishing other processes in conjunction with other components. For some parts which have been described in the above embodiments, the description thereof is omitted here for brevity.

At block 1602, the radio access network device receives a request for creating a cell shaping beam for covering at least a part of a flight route of an aircraft from an operations support system. The request includes at least one cell shaping parameter. For example, the OSS may send the request at block 1504 of FIG. 15, and then the radio access network device may receive the request from the OSS. As described above, the flight route of the aircraft may be determined based on at least one of position information regarding a flight mission of the aircraft, a service quality requirement of the aircraft, or the cell information. The position information of the flight mission of the aircraft may include a start position and an end position of the flight mission of the aircraft. The cell information includes at least one of aerial coverage capability of a cell; a coverage area of a cell; an antenna orientation of a cell; or a cell shaping state of a cell. The radio access network device may be along the flight route of the aircraft. The aircraft may be an unmanned aerial vehicle or an aerial user equipment. The cell shaping beam may have a large angular spread for a direction along the flight route of the aircraft and a small angular spread for other directions.

At block 1604, the radio access network device creates the cell shaping beam for covering at least a part of the flight route of the aircraft based on the at least one cell shaping parameter.

At block 1606, optionally, the radio access network device receives a command from the operations support system to shut down at least one apparatus related to at least one antenna of the radio access network device.

At block 1608, optionally, the radio access network device shutting down the at least one apparatus related to at least one antenna of the radio access network device based on the command.

FIG. 17 is a flowchart illustrating a method 1700 according to an embodiment of the present disclosure. The method 1700 illustrated in FIG. 17 may be performed by an aircraft or an apparatus communicatively coupled to the aircraft. As such, the aircraft may provide means or modules for accomplishing various parts of the method 1700 as well as means or modules for accomplishing other processes in conjunction with other components. For some parts which have been described in the above embodiments, the description thereof is omitted here for brevity.

At block 1702, the aircraft determines to perform a flight mission along a flight route. At least one cell shaping beam is created for covering at least a part of the flight route of the aircraft. As described above, the flight route of the aircraft may be determined based on at least one of position information regarding a flight mission of the aircraft, a service quality requirement of the aircraft, or the cell information. The position information of the flight mission of the aircraft may include a start position and an end position of the flight mission of the aircraft. The cell information includes at least one of aerial coverage capability of a cell; a coverage area of a cell; an antenna orientation of a cell; or a cell shaping state of a cell. The radio access network device may be along the flight route of the aircraft. The aircraft may be an unmanned aerial vehicle or an aerial user equipment. The cell shaping beam may have a large angular spread for a direction along the flight route of the aircraft and a small angular spread for other directions.

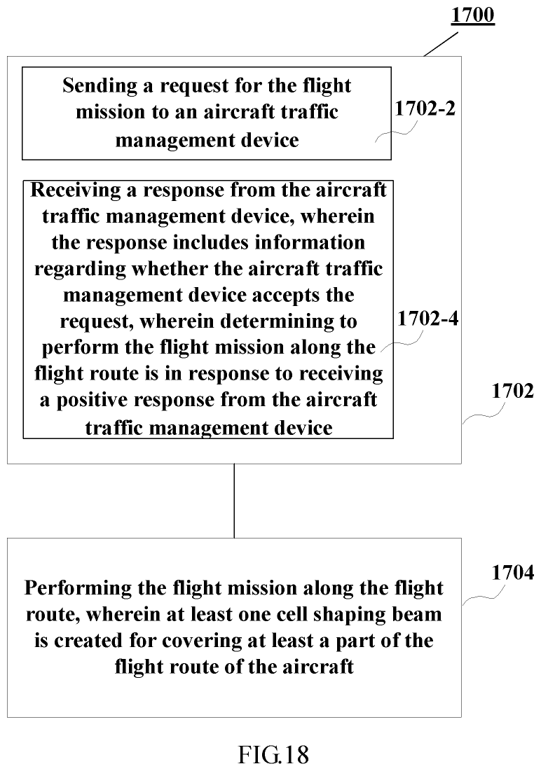

In an embodiment, the aircraft actively sends the request for a flight mission to the aircraft traffic management device. In this case, block 1702 may include two sub blocks 1702-2 and 1702-4 as shown in FIG. 18. At sub block 1702-2, the aircraft sends a request for the flight mission to an aircraft traffic management device. For example, an end user of the aircraft may request a flight mission from point A to point B, and then the aircraft may send the request to aircraft traffic management device. In an embodiment, the request may include the flight route of the aircraft. In another embodiment, the request may include the position information regarding a flight mission of the aircraft and/or a service quality requirement of the aircraft. At sub block 1702-4, the aircraft may receive a response from the aircraft traffic management device. The response includes information regarding whether the aircraft traffic management device accepts the request. For example, the aircraft traffic management device sends the response to the aircraft at block 1310 of FIG. 13, and then the aircraft may receive the response from the aircraft traffic management device. In this embodiment, the aircraft may determine to perform the flight mission along the flight route in response to receiving a positive response from the aircraft traffic management device. For example, when the aircraft traffic management device accepts the request, it may send a response to notify the aircraft that the flight mission can be performed.

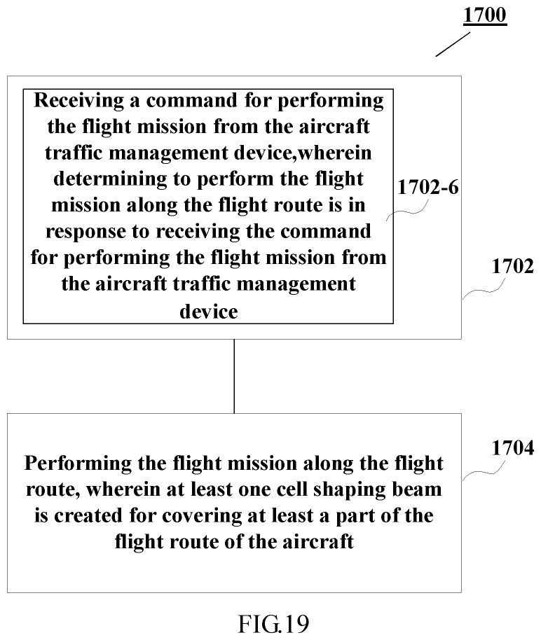

In another embodiment, the aircraft traffic management device may actively instruct the aircraft to perform a flight mission without a request from the aircraft. In this case, block 1702 may include a sub block 1702-6 as shown in FIG. 19. At sub block 1702-6, the aircraft receives a command for performing the flight mission from the aircraft traffic management device. For example, the aircraft traffic management device may send the command for performing the flight mission to the aircraft at block 1408 of FIG. 14, and then the aircraft receives the command for performing the flight mission from the aircraft traffic management device. In this embodiment, the aircraft may determine to perform the flight mission along the flight route in response to receiving the command for performing the flight mission from the aircraft traffic management device.

At block 1704, the aircraft performs the flight mission along the flight route. At least one cell shaping beam is created for covering at least a part of the flight route of the aircraft.

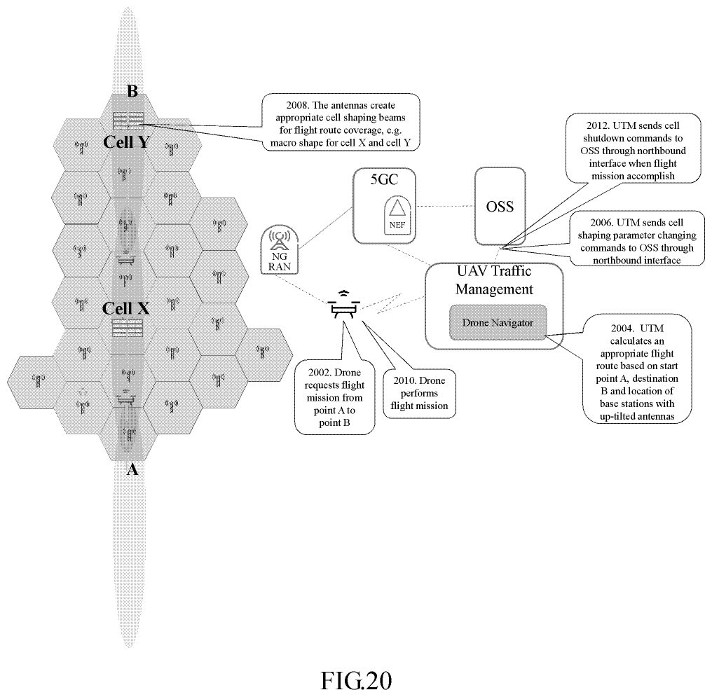

FIG. 20 schematically shows an example of how the proposed solution works according to an embodiment of the present disclosure. This method is implemented in fifth generation core (5GC) network. NG RAN denotes next generation radio access network, NEF denotes Network Exposure Function.

At step 2002, an end user requests a drone flight mission from point A to point B, the request is sent to UTM (UAV traffic management).

At step 2004, UTM performs pre-flight legality check from identity authentication. UTM maintains an UAV cell list for flight route construction. The cell list may include cells with aerial coverage capability, their coverage area, antenna orientation, cell shaping state, etc. UTM needs define a flight route according to flight mission and cell list information.

Assuming that the antennas with cell shaping capability are installed up-tiled with 90 degrees and east-west orientation, for flight mission from point A to point B, the antennas along the line A-B can create macro cell shaping, which means these cells have very a larger angular spread for north-south direction and a narrow angular spread for east-west direction.

At step 2006, UTM sends a cell shaping parameter changing command to OSS through northbound interface of the OSS.

At step 2008, OSS and RAN (radio access network) device confirm the changing requests and the antennas create appropriate cell shaping beams for flight route coverage, e.g., macro cell shape for cell X and cell Y in FIG. 20 and these cells form a north-south route coverage from point A to point B.

At step 2010, the drone performs the flight mission.

At step 2012, after the flight mission is accomplished, UTM sends cell shutdown commands to OSS through the northbound interface, in order to save energy and avoid interference to ground traffic.

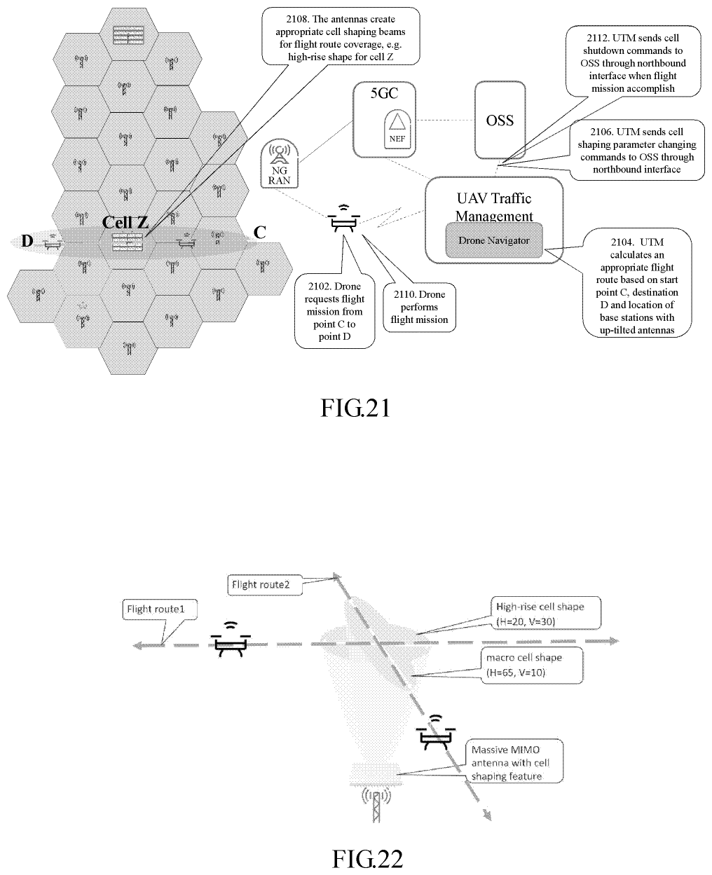

FIG. 21 schematically shows an example of how the proposed solution works according to another embodiment of the present disclosure. This method is implemented in 5GC network.

At step 2102, an end user requests a drone flight mission from point C to point D, the request was sent to UTM.

At step 2104, UTM performs pre-flight legality check from identity authentication. UTM maintains an UAV cell list for flight route construction. The cell list includes cells with aerial coverage capability, their coverage area, antenna orientation, cell shaping state, etc. UTM needs define a flight route according to flight mission and cell list information.

Assuming that the antennas with cell shaping capability are installed up-tiled with 90 degrees and east-west orientation, for flight mission from point C to point D, the antennas along the line C-D can create high-rise cell shaping, which means the cell has very a larger angular spread for east-west direction and a small angular spread for north-south direction.

At step 2106, UTM sends a cell shaping parameter changing command to OS S through northbound interface of the OS S.

At step 2108, OSS and RAN (radio access network) device confirm the changing requests and the antennas create appropriate cell shaping beams for flight route coverage, e.g., high-rise cell shape for cell Z in FIG. 21 and the cell Z forms an east-west route coverage from point C to point D.

At step 2110, the drone performs the flight mission.

At step 2112, after the flight mission is accomplished, UTM sends cell shutdown commands to OSS through the northbound interface, in order to save energy and avoid interference to ground traffic.

The various blocks shown in FIGS. 11-21 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

According to various embodiments of the disclosure, aviation authorities may define the rules of drone operation, in an effort to address the safety issues for drones. This includes mandating drone traffic management systems similar to the air traffic control systems of manned aviation. Aerial flight route may be mandatory planned by UTM for commercial flight. Also UTM can communicate with cellular networks by northbound interface of OSS, for example, send a request to change cell shaping parameter. Up-tilted antenna to the sky can change its cell shaping to macro or high-rise cell shaping according to the flight mission request. FIG. 22 schematically shows an example of cell shaping. As shown in FIG. 22, there are two flight routes 1 and 2. The massive MIMO (multiple-input and multiple-output) antenna with cell shaping feature can create a Macro cell shape for flight route 2 and high-rise cell shape for flight route 1. This basic component as shown in FIG. 22 is able to put together to form a grid coverage with many available flight routes.

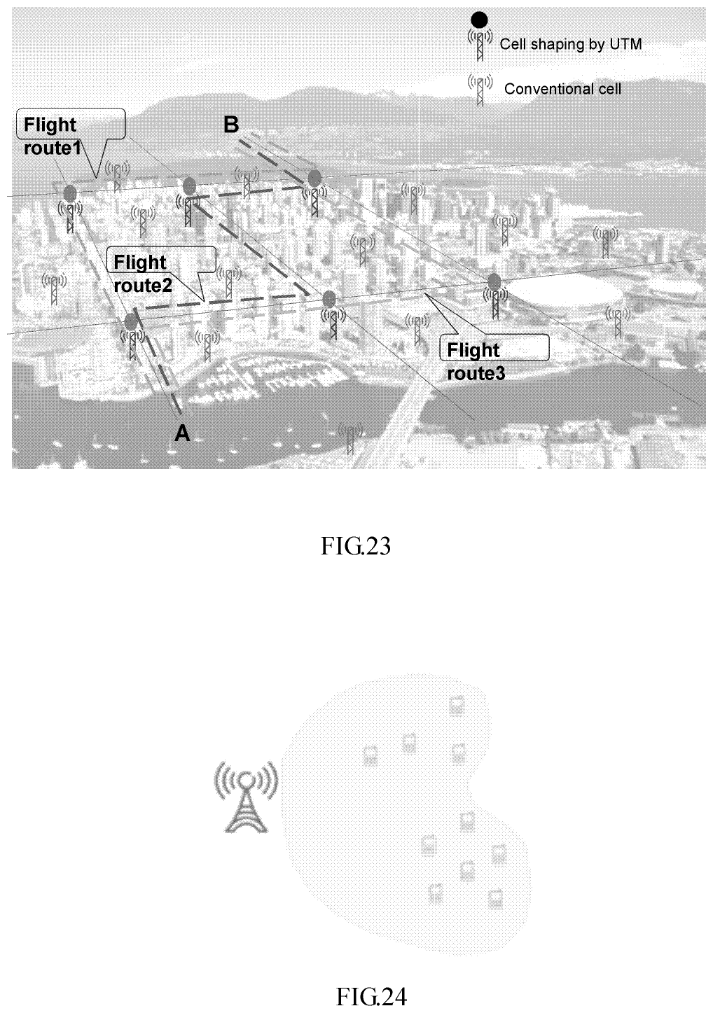

According to various embodiments of the disclosure, a grid aerial coverage may be formed with sparse antennas with cell shaping capability and aircraft traffic management device such as UTM. The aircraft traffic management device such as UTM can define several available flight routes by changing the cell shape of each cell and select the best one according to flight mission request, quality of service (QoS) requirement, cell traffic load, etc. FIG. 23 schematically shows an example of flight routes according to an embodiment of the present disclosure. As shown, UTM and cellular network can create three aerial routes for flight mission from point A to point B.

According to various embodiments of the disclosure, additional cell shapes may be developed. More flexible flight route can be created by new cell shapes. FIG. 24 schematically shows “L” shape of cell, which may be a better choice for flight route corner.

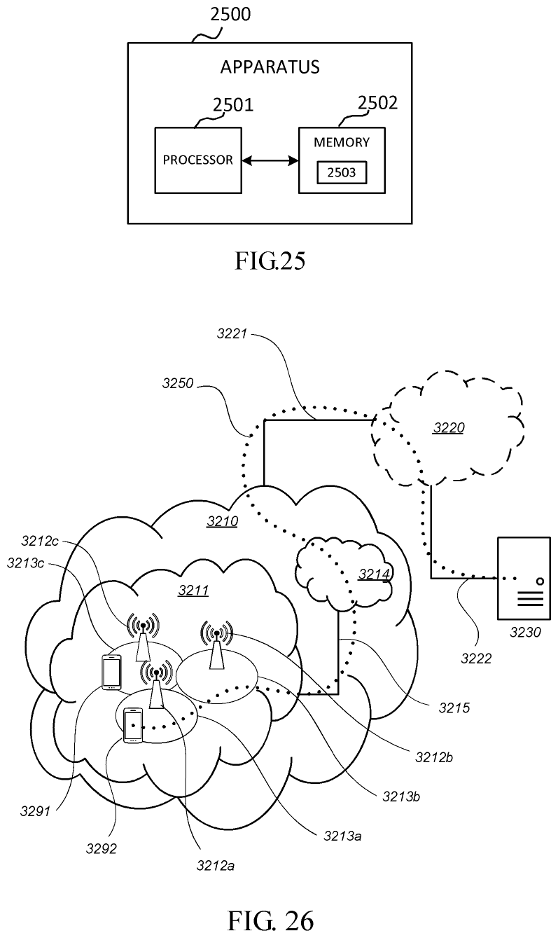

FIG. 25 is a block diagram illustrating an apparatus 2500 according to various embodiments of the present disclosure. As shown in FIG. 25, the apparatus 2500 may comprise one or more processors such as processor 2501 and one or more memories such as memory 2502 storing computer program codes 2503. The memory 2502 may be non-transitory machine/processor/computer readable storage medium. In accordance with some exemplary embodiments, the apparatus 2500 may be implemented as an integrated circuit chip or module that can be plugged or installed into an aircraft traffic management device as described with respect to FIGS. 11-14, an operations support system as described with respect to FIG. 15, a radio access network device as described with respect to FIG. 16, or an aircraft as described with respect to FIGS. 17-19. In such case, the apparatus 1000 may be implemented as an aircraft traffic management device as described with respect to FIGS. 11-14, an operations support system as described with respect to FIG. 15, a radio access network device as described with respect to FIG. 16, or an aircraft as described with respect to FIGS. 17-19.

In some implementations, the one or more memories 2502 and the computer program codes 2503 may be configured to, with the one or more processors 2501, cause the apparatus 2500 at least to perform any operation of the method as described in connection with FIGS. 11-14. In other implementations, the one or more memories 2502 and the computer program codes 2503 may be configured to, with the one or more processors 2501, cause the apparatus 2500 at least to perform any operation of the method as described in connection with FIG. 15. In other implementations, the one or more memories 2502 and the computer program codes 2503 may be configured to, with the one or more processors 2501, cause the apparatus 2500 at least to perform any operation of the method as described in connection with FIG. 16. In other implementations, the one or more memories 2502 and the computer program codes 2503 may be configured to, with the one or more processors 2501, cause the apparatus 2500 at least to perform any operation of the method as described in connection with FIGS. 17-19. Alternatively or additionally, the one or more memories 2502 and the computer program codes 2503 may be configured to, with the one or more processors 2501, cause the apparatus 2500 at least to perform more or less operations to implement the proposed methods according to the exemplary embodiments of the present disclosure.

Various embodiments of the present disclosure provide an apparatus which may comprise a determining unit and a sending unit. In an exemplary embodiment, the apparatus may be implemented in an aircraft traffic management device. The determining unit may be operable to carry out the operation in block 1102 of FIG. 11, and the sending unit may be operable to carry out the operation in block 1104 of FIG. 11.

Various embodiments of the present disclosure provide an apparatus which may comprise a receiving unit and a sending unit. In an exemplary embodiment, the apparatus may be implemented in an operations support system. The receiving unit may be operable to carry out the operation in block 1502 of FIG. 15, and the sending unit may be operable to carry out the operation in block 1504 of FIG. 15.

Various embodiments of the present disclosure provide an apparatus which may comprise a receiving unit and a creating unit. In an exemplary embodiment, the apparatus may be implemented in a radio access network device. The receiving unit may be operable to carry out the operation in block 1602 of FIG. 16, and the creating unit may be operable to carry out the operation in block 1604 of FIG. 16.

Various embodiments of the present disclosure provide an apparatus which may comprise a determining unit and a performing unit. In an exemplary embodiment, the apparatus may be implemented in an aircraft. The determining unit may be operable to carry out the operation in block 1702 of FIG. 17, and the performing unit may be operable to carry out the operation in block 1704 of FIG. 17.

With reference to FIG. 26, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 26 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

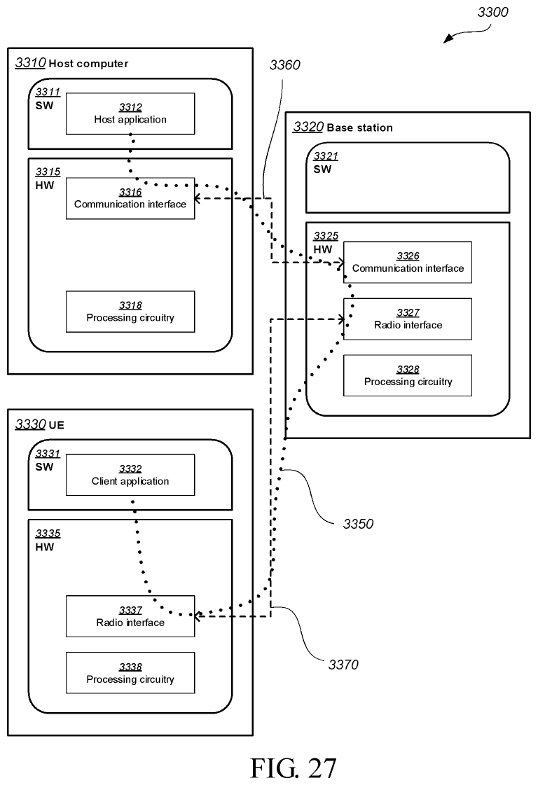

Example implementations, in accordance with an embodiment, of the UE, base station and host computer discussed in the preceding paragraphs will now be described with reference to FIG. 27. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 27) served by base station 3320. Communication interface 3326 may be configured to facilitate connection 3360 to host computer 3310. Connection 3360 may be direct or it may pass through a core network (not shown in FIG. 27) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 27 may be similar or identical to host computer 3230, one of base stations 3212a, 3212b, 3212c and one of UEs 3291, 3292 of FIG. 26, respectively. This is to say, the inner workings of these entities may be as shown in FIG. 27 and independently, the surrounding network topology may be that of FIG. 26.

In FIG. 27, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

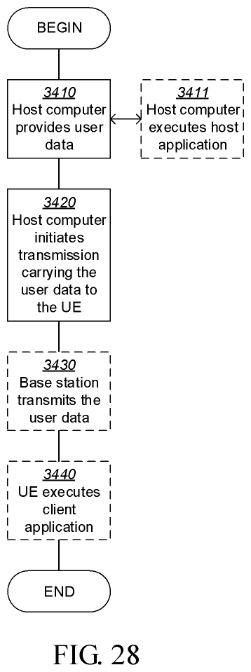

FIG. 28 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 28 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

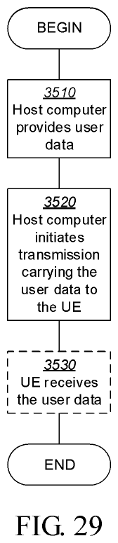

FIG. 29 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 29 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

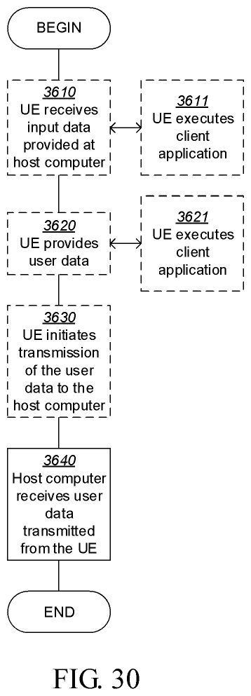

FIG. 30 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 30 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

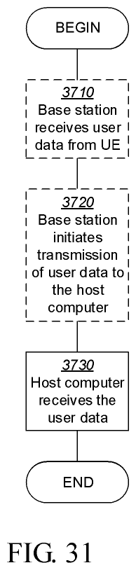

FIG. 31 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 31 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 1600 as describe with respect to FIG. 16.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary 1600 as describe with respect to FIG. 16.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 1700 as describe with respect to FIG. 17.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 1700 as describe with respect to FIG. 17.

According to some exemplary embodiments, there is provided a method implemented in a communication system which may include a host computer, a base station and a UE. The method may comprise, at the host computer, receiving user data transmitted to the base station from the UE which may perform any step of the exemplary method 1700 as describe with respect to FIG. 17.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 1700 as describe with respect to FIG. 17.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 1600 as describe with respect to FIG. 16.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 1600 as describe with respect to FIG. 16.

According to an aspect of the disclosure it is provided a computer program product being tangibly stored on a computer readable storage medium and including instructions which, when executed on at least one processor, cause the at least one processor to carry out any of the methods 1100, 1200, 1300, 1400, 1500, 1600, 1700, 1800, 1900, 2000 and 2100 as described above.

According to an aspect of the disclosure it is provided a computer-readable storage medium storing instructions which when executed by at least one processor, cause the at least one processor to carry out any of the methods 1100, 1200, 1300, 1400, 1500, 1600, 1700, 1800, 1900, 2000 and 2100 as described above.

Embodiments herein afford many advantages, of which a non-exhaustive list of examples follows. Some embodiments herein may provide a cost efficient aerial coverage scheme, which can save more cost than conventional flight route coverage scheme. Some embodiments herein may require less neighbor cells and less handover. In some embodiments herein, the cells for aerial coverage can be shut down by the aircraft traffic management device such as UTM when there is no drone flight mission, which can reduce DL/UL interference to terrestrial users and save energy. In some embodiments herein, the emitted power of the radio access network device may be concentrated to a small area by cell shaping, which can increase the signal quality for the aerial coverage, increase aerial coverage distance and reduce cost. In some embodiments herein, the antennas can create different appropriate cell shaping beams for different flight route coverage. The embodiments herein are not limited to the features and advantages mentioned above. A person skilled in the art will recognize additional features and advantages upon reading the following detailed description.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RANI (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-46. (canceled)

47. A method performed by an aircraft traffic management device, the method comprising:
determining at least one cell shaping parameter based on cell information and a flight route of an aircraft; and
sending a request for creating at least one cell shaping beam for covering at least a part of the flight route of the aircraft to an operations support system (OSS), wherein the request includes the at least one cell shaping parameter.

48. The method according to claim 47, wherein:
the method further comprises determining the flight route of the aircraft based on at least one of the following: position information regarding a flight mission of the aircraft, a service quality requirement of the aircraft, and the cell information; and
the position information of the flight mission of the aircraft includes a start position and an end position of the flight mission of the aircraft.

49. The method according to claim 47, wherein the cell information includes at least one of the following:
aerial coverage capability of a cell;
a coverage area of a cell;
a load of a cell;
an antenna orientation of a cell; and
a cell shaping state of a cell.

50. The method according to claim 47, wherein:
the at least one cell shaping beam is created by at least one antenna of at least one radio access network device along the flight route of the aircraft; and
the at least one antenna has a cell shaping capability and faces toward the sky.

51. The method according to claim 47, wherein the at least one cell shaping beam has a large angular spread for a direction along the flight route of the aircraft and a small angular spread for other directions.

52. The method according to claim 47, further comprising
receiving a request for a flight mission of the aircraft from the aircraft; and
sending a response to the aircraft, wherein the response includes information regarding whether the aircraft traffic management device accepts the request.

53. The method according to claim 47, further comprising one or more of the following:
sending a command for performing the flight mission to the aircraft; and
sending a command to the OSS to shut down at least one apparatus related to at least one antenna of at least one radio access network device creating the at least one cell shaping beam.

54. A method performed by an operations support system, the method comprising:
receiving a request for creating at least one cell shaping beam for covering at least a part of a flight route of an aircraft from an aircraft traffic management device, wherein the request includes at least one cell shaping parameter that is based on cell information and a flight route of the aircraft; and
sending the request for creating at least one cell shaping beam for covering at least a part of the flight route of the aircraft to at least one radio access network device.

55. The method according to claim 54, wherein:
the flight route of the aircraft is based on at least one of the following: position information regarding a flight mission of the aircraft, a service quality requirement of the aircraft, and the cell information; and
the position information of the flight mission of the aircraft includes a start position and an end position of the flight mission of the aircraft.

56. The method according to claim 54, wherein the cell information includes at least one of the following:
aerial coverage capability of a cell;
a coverage area of a cell;
an antenna orientation of a cell; and
a cell shaping state of a cell.

57. The method according to claim 54, wherein one or more of the following applies:
the radio access network device is along the flight route of the aircraft; and
the at least one cell shaping beam has a large angular spread for a direction along the flight route of the aircraft and a small angular spread for other directions.

58. The method according to claim 54, further comprising
receiving a command from the aircraft traffic management device to shut down at least one apparatus related to at least one antenna of the at least one radio access network device; and
sending the command to the at least one radio access network device to shut down at least one apparatus related to at least one antenna of the at least one radio access network device.

59. A method performed by a radio access network device, the method comprising:
receiving a request for creating a cell shaping beam for covering at least a part of a flight route of an aircraft from an operations support system, wherein the request includes at least one cell shaping parameter that is based on cell information and a flight route of the aircraft; and
creating the cell shaping beam for covering at least a part of the flight route of the aircraft based on the at least one cell shaping parameter.

60. The method according to claim 59, wherein:
the flight route of the aircraft is based on at least one of the following: position information regarding a flight mission of the aircraft, a service quality requirement of the aircraft, and the cell information; and
the position information of the flight mission of the aircraft includes a start position and an end position of the flight mission of the aircraft.

61. The method according to claim 59, wherein the cell information includes at least one of the following:
aerial coverage capability of a cell;
a coverage area of a cell;
an antenna orientation of a cell; and
a cell shaping state of a cell.

62. The method according to claim 59, wherein one or more of the following applies:
the radio access network device is along the flight route of the aircraft; and
the cell shaping beam has a large angular spread for a direction along the flight route of the aircraft and a small angular spread for other directions.

63. The method according to claim 59, further comprising:
receiving a command from the operations support system to shut down at least one apparatus related to at least one antenna of the radio access network device; and
shutting down the at least one apparatus related to at least one antenna of the radio access network device based on the command.

64. An aircraft traffic management device comprising:
one or more processors; and
one or more memories storing computer program codes,
wherein execution of the computer program codes by the one or more processors causes the aircraft traffic management device to perform operations corresponding to the method of claim 47.

65. An operations support system comprising:
one or more processors; and
one or more memories storing computer program codes,
wherein execution of the computer program codes by the one or more processors causes the operations support system to perform operations corresponding to the method of claim 54.

66. A radio access network device comprising:
one or more processors; and
one or more memories storing computer program codes,
wherein execution of the computer program codes by the one or more processors causes the radio access network device to perform operations corresponding to the method of claim 59.
